(19) United States
(12) Patent Application Publication
(10) Pub. No.: US 2014/0171166 A1
(43) Pub. Date: Jun. 19, 2014

(54) CONTROLLING A MOVEMENT OF A PLURALITY OF GRAPHICAL OBJECTS IN A TILE-MATCHING PUZZLE

(71) Applicant: Naftali MERARI, Tel-Aviv (IL)

(72) Inventor: Naftali MERARI, Tel-Aviv (IL)

(21) Appl. No.: 14/108,534

(22) Filed: Dec. 17, 2013

Related U.S. Application Data
(60) Provisional application No. 61/737,864, filed on Dec. 17, 2012.

(51) Int. Cl. A63F 13/00

(52) U.S. Cl. CPC A63F 13/005
USPC 463/9

(57) ABSTRACT

A computerized method of controlling a movement of graphical objects. The method comprises generating a display of a set of graphical objects arranged in a mesh having columns and rows, selecting by a user a graphical object having a differentiating visual characteristic from the graphical objects in a certain column from the columns and in a certain row from the rows, in response to the selecting, automatically rearranging a group of graphical objects located in the certain row and the certain column in the mesh and having the differentiating visual characteristic, identifying a presence or absence of at least one sequence of at least three neighboring graphical objects having a common differentiating visual characteristic in an outcome of the automatic rearranging, and if the at least one sequence is identified, removing the at least one sequence from the mesh and adding replacement graphical objects to the mesh.

### RELATED APPLICATION

This application claims the benefit of priority under 35 USC §119(e) of U.S. Provisional Patent Application No. 61/737,864 filed Dec. 17, 2012, the contents of which are incorporated herein by reference in their entirety.

### FIELD AND BACKGROUND OF THE INVENTION

The present invention, in some embodiments thereof, relates to a video game and, more particularly, but not exclusively, to computerized methods and systems of controlling a movement of a plurality of graphical objects in a tile-matching puzzle.

Video games provide recreational experiences for users for many years. Video games are played at arcades or at places of business, such as restaurants or taverns. Video games are also played on home video systems, personal computers, mobile devices, such as laptops, mobile phones (e.g. Smartphones), and tablets. More recently, video games have been widely played on computers that are connected to a network such as the Internet, for example via browsers.

One of the most common types of video games is a tile-matching puzzle video game. In these games, the objective is to swap one gem with an adjacent gem to form a horizontal or vertical chain of three or more gems. Bonus points are given when more than three identical gems are formed or form two lines of identical gems in one swap. Gems disappear when chains are formed and gems fall from the top to fill in gaps. Sometimes chain reactions, called cascades, are triggered, where chains are formed by the falling gems. Cascades are awarded with bonus points.

### SUMMARY OF THE INVENTION

According to some embodiments of the present invention there is provided a computerized method of controlling a movement of a plurality of graphical objects in a mesh. The method comprises generating, using a processor, a display of a set of a plurality of graphical objects on a client terminal of a user, the plurality of graphical objects are arranged in a mesh having a plurality of columns and a plurality of rows, the plurality of graphical objects, selecting by a user a graphical object having a differentiating visual characteristic from the plurality of graphical objects in a certain column from the plurality of columns and in a certain row from the plurality of rows, in response to the selecting, automatically rearranging a group of graphical objects located in the certain row and the certain column in the mesh and having the differentiating visual characteristic, identifying a presence or absence of at least one sequence of at least three neighboring graphical objects having a common differentiating visual characteristic in an outcome of the automatic rearranging, and if the at least one sequence is identified, removing the at least one sequence from the mesh and adding a plurality of replacement graphical objects to the mesh.

Optionally, the automatically rearranging comprises relocating the group with neighboring graphical objects which are closer to the selected graphical object in the certain row and the certain column.

Optionally, the selecting is performed by one of a single selection action.

More optionally, the single selection action is a single finger tap on a touch screen displaying the mesh.

More optionally, the single selection action is a single click performed when a cursor is maneuvered to be correlated with a presentation of the selected graphical object.

Optionally, the method further comprises sequentially and iteratively repeating the selecting, the automatically rearranging, the automatically checking, and the removing during a game session.

Optionally, the differentiating visual characteristic is selected from a group consisting of color, shape, and hue.

Optionally, the method further comprises updating a score of the user according to the at least one sequence.

More optionally, the score is defined according to a length of the sequence.

Optionally, the selecting is performed by pressing or tapping on the selected graphical object for a period, wherein the rearranging is determined according to the length of the period.

More optionally, the period defines a number of tiles in the mesh each one of the graphical objects having the differentiating visual characteristic of the selected graphical object is relocated.

Optionally, the set comprises at least one bonus indicative graphical object; wherein the automatically checking comprises checking if the sequence includes the at least one bonus indicative graphical object.

More optionally, the at least one bonus indicative graphical object is reallocated during the rearrangement.

More optionally, the at least one bonus indicative graphical object remains in place during the rearrangement.

Optionally, further comprises display a set of target tiles in the mesh; wherein the at least one sequence is at least one sequence formed in the set of target tiles.

Optionally, the selecting, automatically rearranging, identifying, removing, and adding are performed per game iteration in a multiplayer game session; wherein in each iteration the selecting is performed by another of a plurality of players.

According to some embodiments of the present invention there is provided a game system for allowing a user to control a movement of a plurality of graphical objects in a mesh. The game system comprises a processor, a mesh generation module which generates, using the processor, a display of a set of a plurality of graphical objects on a client terminal of a user, the plurality of graphical objects are arranged in a mesh having a plurality of columns and a plurality of rows, the plurality of graphical objects, and a user interface module which allows a user to select a graphical object having a differentiating visual characteristic from the plurality of graphical objects in a certain column from the plurality of columns and in a certain row from the plurality of rows. In response to the user selection, the mesh generation module automatically rearranges graphical objects having the differentiating visual characteristic of the selected graphical object in the certain row and the certain column. The mesh generation module automatically identifies a presence or absence of at least one sequence of at least three neighboring graphical objects having a common differentiating visual characteristic in an outcome of the automatically rearranged mesh so that if the at least one sequence is formed, the at least one sequence is removed from the mesh.

Optionally, the system is a mobile device that has a touch screen; wherein the user interface module which allows the user to select the graphical object by a single tap on the touch screen.

Optionally, the system is a network node that forwards the display to be presented in a browser executed by a client terminal which is connected to the network node via a computer network.

Optionally, the user interface allows the user to select the graphical object by tapping on a display or clicking when a cursor is on top of graphical object, the user interface detects a length of a period wherein the user performs the tapping or clicking and determines a relocation of the graphical objects having the differentiating visual characteristic of the selected graphical object accordingly.

According to some embodiments of the present invention there is provided a computerized method of controlling a movement of a plurality of graphical objects in a mesh. The method comprises generating, using a processor, a display of a set of a plurality of graphical objects on a client terminal of a user, the plurality of graphical objects are arranged in a mesh having a plurality of columns and a plurality of rows, the plurality of graphical objects, iteratively performing the following in each of a plurality of game iterations: selecting by a single tap of a user on a touch screen or a single click on a cursor control device a graphical object having a differentiating visual characteristic from the plurality of graphical objects in a certain column from the plurality of columns and in a certain row from the plurality of rows, in response to the selecting, automatically rearranging graphical objects having the differentiating visual characteristic of the selected graphical object and located in the certain row and the certain column, and scoring the user according to a presence or absence of at least one sequence having a common differentiating visual characteristic in an outcome of the automatic rearranging.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of controlling a movement of a plurality of graphical objects in a mesh or grid, such as a tile puzzle mesh, by allowing a user to select a single graphical object with a certain differentiating visual characteristic, according to some embodiments of the present invention;

FIG. 2 is a schematic illustration of a system that allows one or more users to participate in a puzzle tile game, for example by implementing the method described in FIG. 1, according to some embodiments of the present invention;

FIG. 3 is an exemplary screenshot of a display of a mesh of a plurality of graphical objects, colored pearls, which are arranged in a mesh that includes rows and columns, according to some embodiments of the present invention;

FIG. 4 is a screenshot of the mesh depicted in FIG. 3, after the sequence of graphical objects “1”, “2”, and “3” has been formed in response to a selection of graphical object “1” and the respective relocation of the graphical objects “2”, and “3” in response to the selection;

FIGS. 5A-5C are screenshots of changes made to a mesh during a selection of graphical object in an iteration (round) of game session, according to some embodiments of the present invention;

FIGS. 6A-6C are screenshots of changes made to a mesh during a selection of graphical object in an iteration (round) of game session, according to some embodiments of the present invention;

FIG. 7 is a screenshot of the exemplary mesh with a sequence formed with a graphical object that is visually tagged with a bubble therearound, according to some embodiments of the present invention;

FIG. 8 is a screenshot of an exemplary mesh that includes a dynamic graphical object marked with numeral “1”, according to some embodiments of the present invention;

FIG. 9 is a screenshot of the exemplary mesh in FIG. 8 after a user selected graphical object “2”, according to some embodiments of the present invention;

FIG. 10 is a screenshot of an exemplary mesh with a set of marked tiles, according to some embodiments of the present invention; and

FIG. 11 is a screenshot of an exemplary mesh with graphical objects marked with letters, according to some embodiments of the present invention.

### DESCRIPTION OF EMBODIMENTS OF THE INVENTION

The present invention, in some embodiments thereof, relates to a video game and, more particularly, but not exclusively, to computerized methods and systems of controlling a movement of a plurality of graphical objects in a tile-matching puzzle mesh.

According to some embodiments of the preset invention there are provided methods and systems of controlling the location of graphical objects in a mesh or grid which are referred to herein interchangeably, such as a tile puzzle, during some or all of the iterations of a game session according to user selection(s). In each iteration, a user selects a graphical object having one or more visual characteristic(s) in a certain row and column of the mesh, for example a pearl with a certain color. Optionally, the selection is made by a single click and/or finger tap on one of the graphical objects. In response to the selection, graphical objects in the certain row and column with the same one or more visual characteristic(s), such as pearls with the same color, are relocated, for instance moved toward and/or away from the selected graphical object. Sequence(s) of graphical objects with the same visual characteristic(s) which are formed as an outcome of the relocation are now identified and removed, for example of three or more graphical objects. These sequences optionally entitle the user with scores and replaced with new visual objects. These iterations are repeated during the game session, optionally under time constrain(s) and/or a limitation of rounds (i.e. number of game iterations).

Optionally, in the certain row and column, graphical objects having the same visual characteristic(s) of the selected graphical object are relocated to tiles which are closer to the selected graphical object, for example to the closest tiles to the tile of the selected graphical object. Graphical objects may be advanced toward the selected graphical object by one, two, five, ten or any intermediate or larger number of tiles. Optionally, relocation of a certain graphical object is performed by a swap with a neighboring graphical object. Optionally, the time a user clicks a mouse during a selection determines how many tiles graphical objects are advanced, for example how many tiles they advance toward the selected graphical object. Optionally, such an action may or may not end in forming a sequence.

Optionally, the user performs his selection on a touch screen based client terminal. In such embodiments, a user selects graphical objects by a single finger tap. Optionally, the user performs his selection using a cursor, displayed on a screen of client terminal. In such embodiments, a user selects graphical objects by a single click when the cursor is on a graphical symbol.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

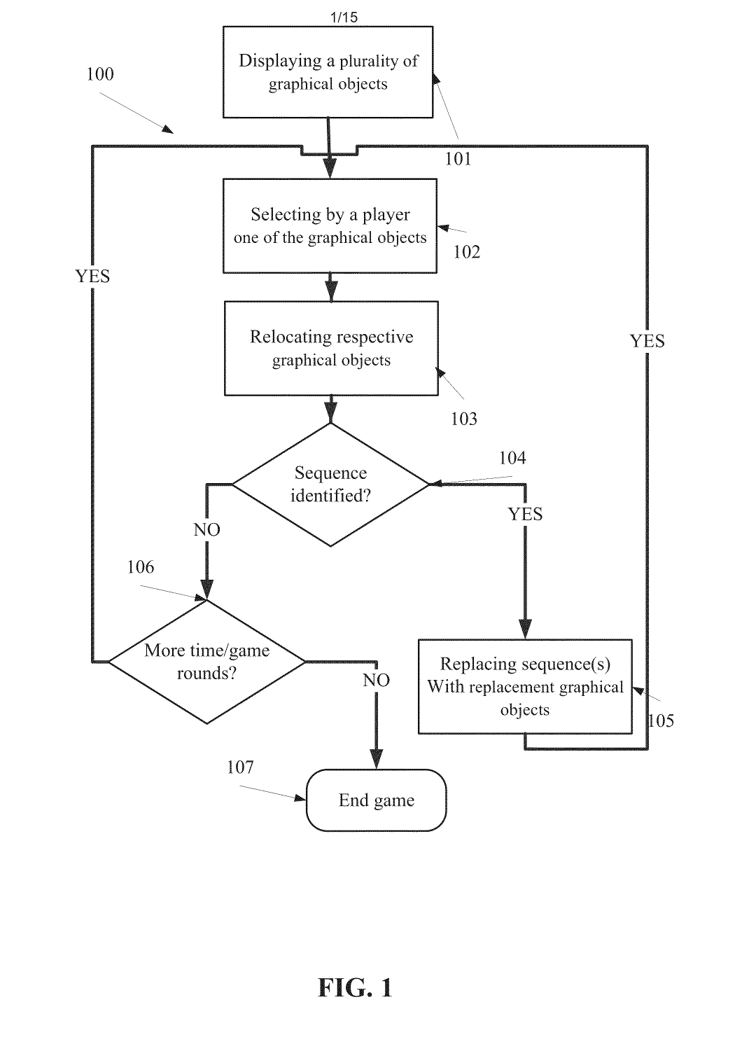

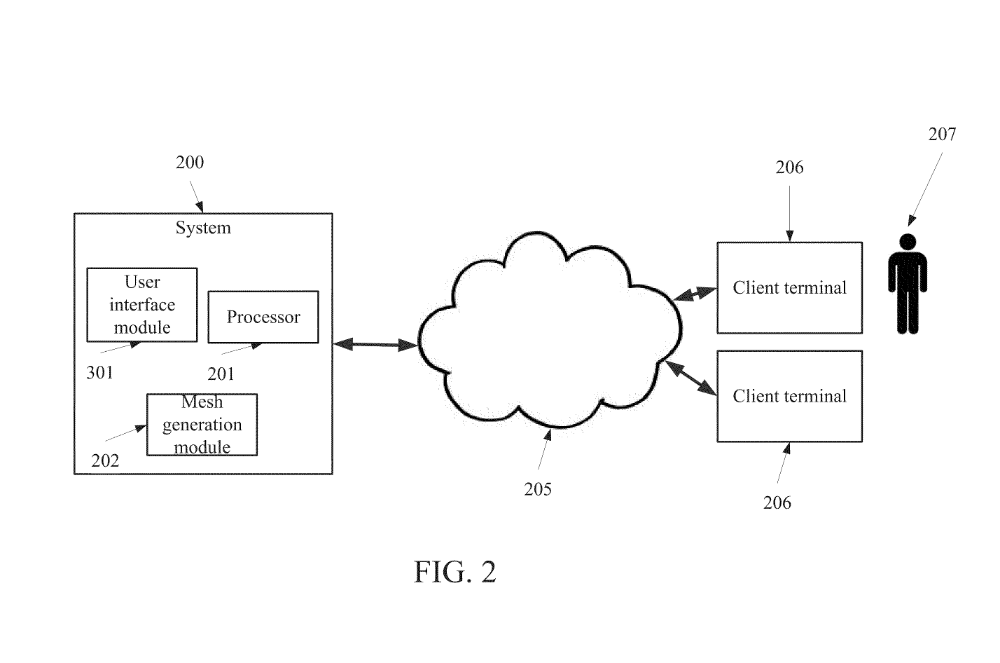

Reference is now made to FIG. 1, which is a flowchart of a method 100 of controlling a movement of a plurality of graphical objects from one tile to another in a mesh, such as a tile puzzle mesh, during a game session by allowing a user to select a graphical object at a certain row and column with a certain differentiating visual characteristic and relocating other graphical objects which share the same differentiating visual characteristic at the certain row and/or column, according to some embodiments of the present invention. The user selection may be performed by a single click and/or finger tap. The differentiating visual characteristic may be color, size, hue, and/or shape. Reallocating is optionally performed by swapping the location of the graphical objects with one or more adjacent graphical objects in the respective row and/or column. If the swapping action forms a horizontal and/or vertical sequence of three or more graphical objects, the sequence is removed from the mesh and new graphical objects are added to replace them. Reference is also made to FIG. 2, which is a schematic illustration of a system that allows one or more users to participate in a puzzle tile game, for example by implementing the method described in FIG. 1. The system 200 includes a processor 201 and a number of modules for managing the control of plurality of graphical objects during a puzzle tile game, for example a mesh generation module 202 and a user interface module 203. The system 200 is optionally implemented as a network node connected to a computer network 105, such as the internet, allowing a plurality of users, such as 207, to use a plurality of client terminals 206, for example laptops, desktops, tablets, and/or mobile phones (e.g. Smartphones) for participating in a game session wherein a puzzle tile mesh is sequentially updated according to user selections, for example as described below. In such embodiments, the plurality of graphical objects may be displayed in a window of a browser, such as explorer™ and/or Chrome™, for instance as an extensible markup language (XML) and/or an asynchronous Javascript and XML (Ajax) component.

Alternatively, the system 200 is implemented to be executed on a client terminal, for example as an application, such as an application store product, for instance an application downloaded to run on iOS 5 installed in iPhone™ 4S.

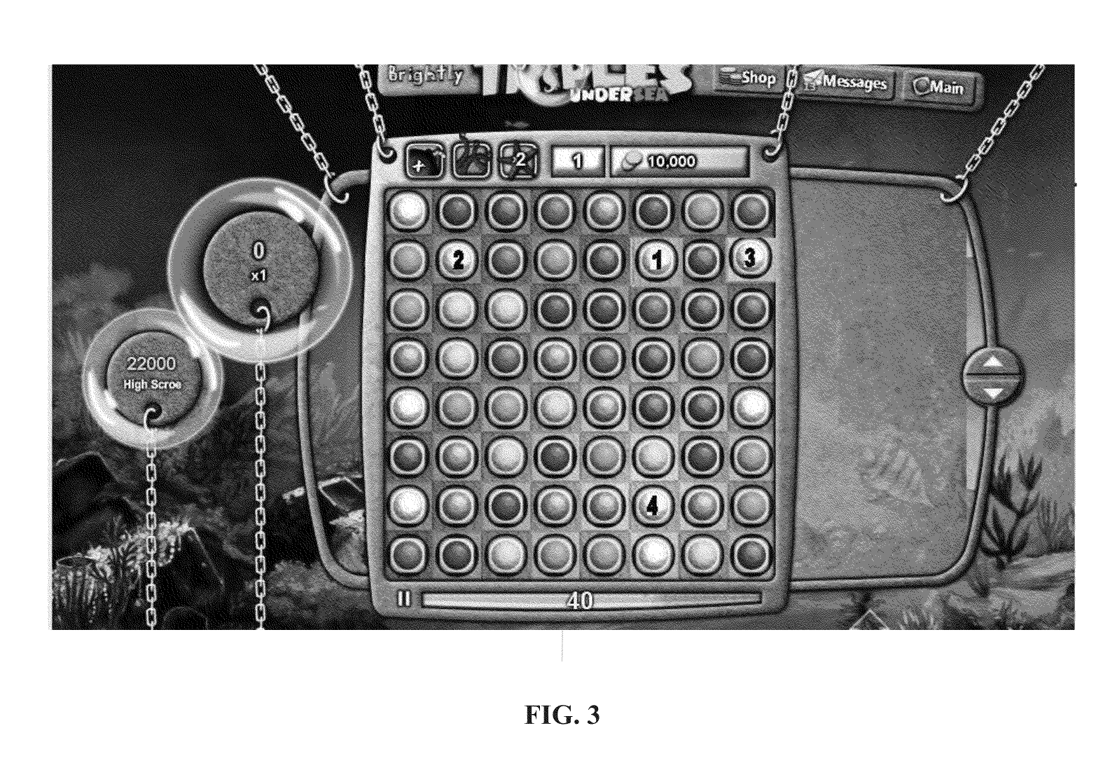

Reference is now made, once again, to FIG. 1. First, as shown at 101, a display of a set of a plurality of graphical objects is generated on a screen and/or other display of a client terminal, for example by the mesh generation module 202. FIG. 3 is a screenshot of an exemplary mesh of a plurality of graphical objects, colored pearls, such as 301, which are arranged in a mesh that includes rows, such as 302, and columns, such as 303. The plurality of graphical objects 301 may be divided (e.g. logically) to subsets which are differentiated from one another by one or more visual characteristics. For example, as depicted in FIG. 3, the differentiating visual characteristic is color (for example red, blue, green, purple, orange, yellow, and white). Other and/or additional differentiating visual characteristics may characterize the graphical objects, such as shape (for example, diamond cut, triangular, circle, and rectangular), size (for example 70%, 100%, and 130% from a reference size), hue and/or the like.

Now, as shown at 102, a user selects one of the graphical objects. Optionally, the display of plurality of graphical objects is presented by a graphical user interface (GUI) that is designed to be displayed on a screen of a client terminal. Optionally, the user selects a certain graphical object of the graphical objects by a single finger tap. In such a manner, a single tap simplifies the user selection iteration in a client terminal that is based on a touch screen, for example a Smartphone. The user may use one finger to perform the selection, for example only his thumb, while holding a client terminal, such as a touch screen based Smartphone. Additionally or alternatively, the user selects a certain graphical object of the graphical objects by a single mouse click when a cursor is located above the certain graphical object. A single click simplifies the user selection iteration in a client terminal based on a regular screen and a mouse, for example a laptop or a desktop. The user is not required to slide a curser while holding a mouse button and/or to select more than one graphical object per iteration. Selection by a single tap and/or a single click provides a smooth user experience and improves the game flow in relation to multiple taps and/or clicks selection. In addition, a single tap and/or a single click selection allows adapting the effect of the selection based on the length of the single tap and/or single click.

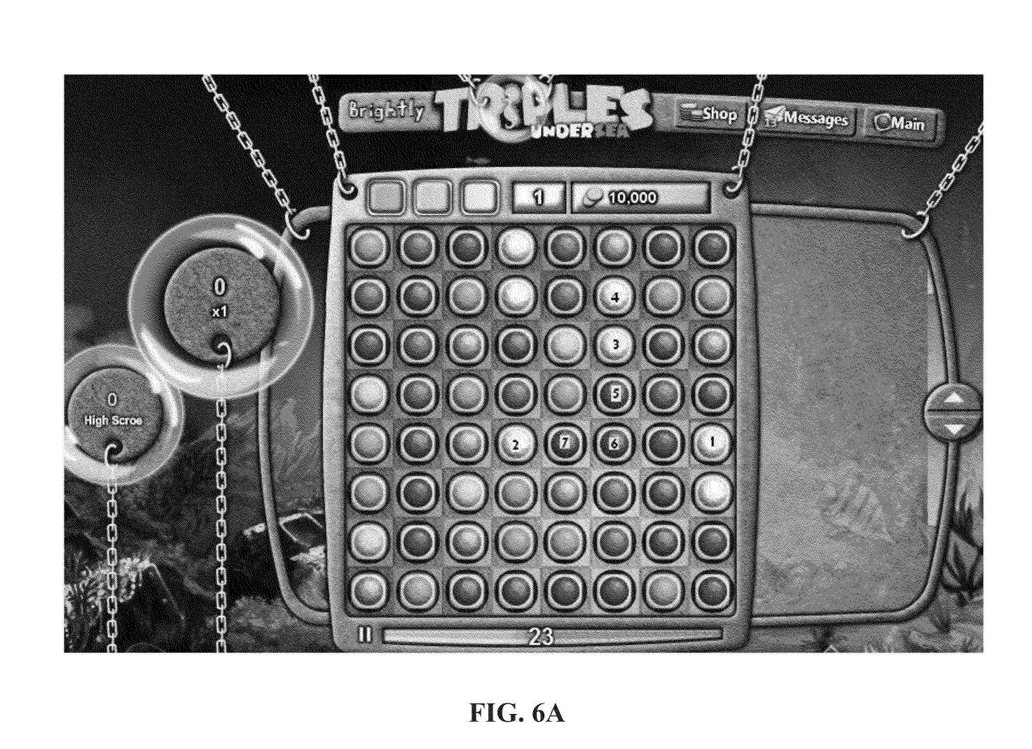

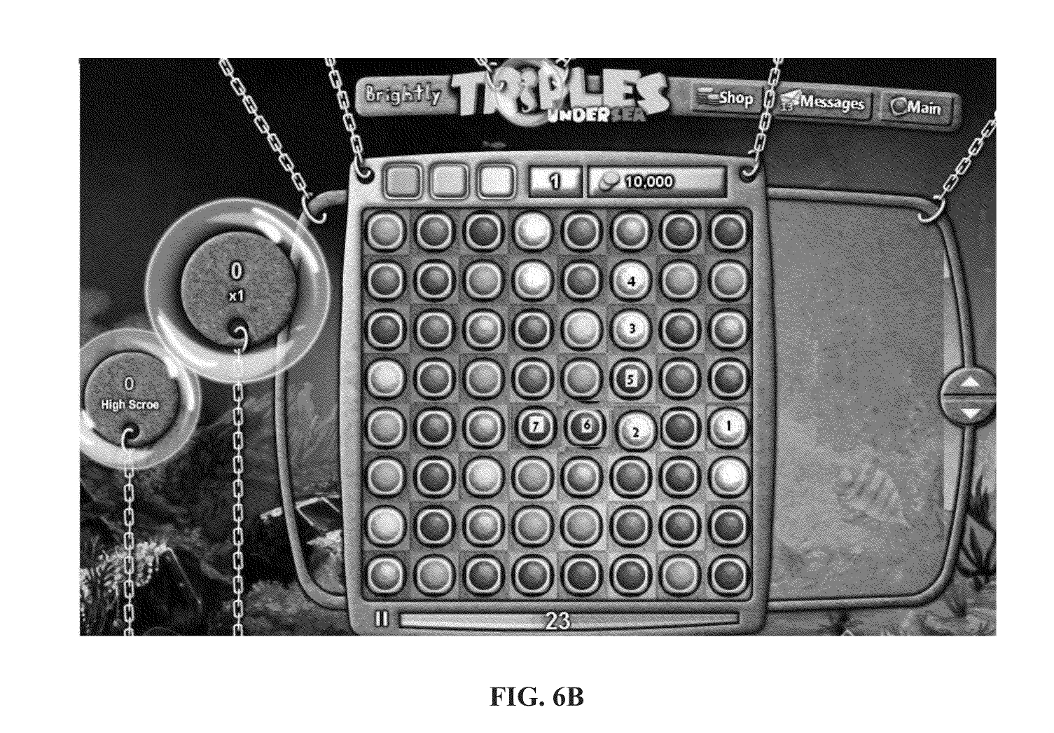

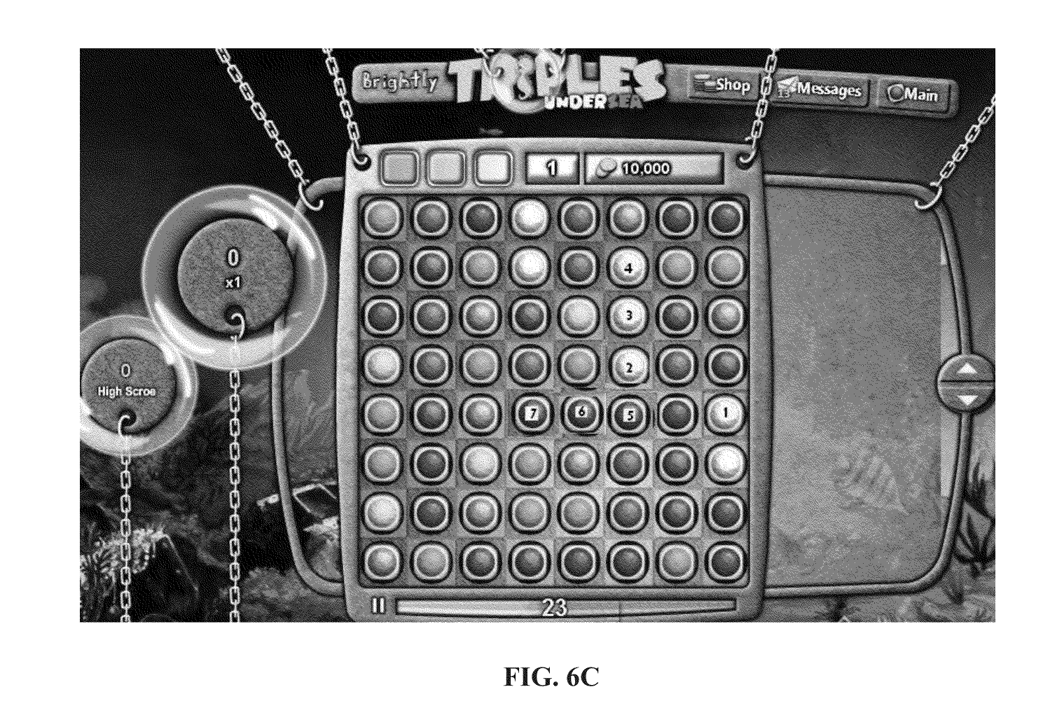

As shown at 103, in response to the user selection, the graphical objects are rearranged in the tiles of the mesh. In such a manner, one or more graphical objects that have the same differentiating visual characteristic in the row and the column of the selected graphical object switch location with neighboring graphical objects closer to the selected graphical object. For brevity, graphical objects having a common differentiating visual characteristic on the same row and/or column which are relocated in response to a user selection are referred to herein as drawable graphical objects. For example, a number of white graphical objects are marked with numerals “1”, “2”, “3”, and “4” in FIG. 3. Selecting the graphical object marked with numeral “1” induces a relocation of graphical objects marked with numerals “2”, “3”, and “4” toward the location of the selected graphical object. In this situation, graphical objects marked with numerals “2”, “3”, and “4” are drawable graphical objects. Optionally, in this process, other graphical objects between the selected graphical objects and the drawable graphical objects are also relocated to allow the relocating of the drawable graphical objects, for example in a swapping action. For example, each of one or more graphical objects to the right of graphical object “2” are relocated one tile to the left to evacuate a new tile for graphical object “2” that is closer to the selected graphical object. Optionally, a user selection relocates all the drawable graphical objects to the tiles which are neighboring to the tile of the selected graphical object. Optionally, a user selection relocates each drawable graphical object to be one tile closer to selected graphical object. Optionally, the time a user clicks and/or taps on a selected graphical object determines the number of tiles each drawable graphical object moves towards the selected graphical object. For example, a selection that lasts no more than 0.2 second relocates drawable graphical objects one tile, a longer selection that lasts between 0.2 and 1 second relocates drawable graphical objects two tiles, an even longer selection that lasts between 1 and 1.5 seconds relocates drawable graphical objects three tiles, and so on and so forth; see also FIGS. 6A-6C. Optionally, regardless of the tap and/or click period, drawable graphical objects not relocated further than the closest tile to the tile of the selected graphical object.

As shown at 104, after the drawable graphical objects and the other graphical objects in the row and/or column of the selected graphical object are reallocated, the graphical objects in the mesh are processed to identify the presence and/or absence of one or more sequence(s) of three or more graphical objects with one or more common visual characteristic(s). These sequence(s) are referred to herein as uniform sequence(s).

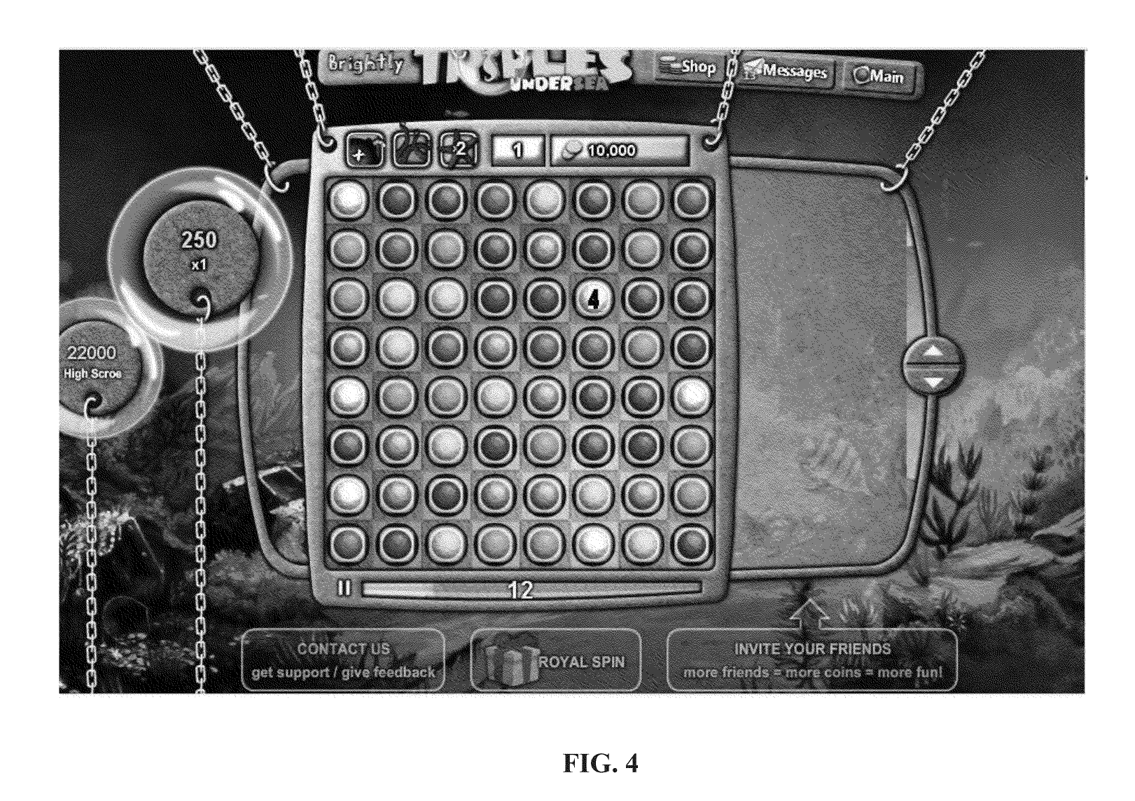

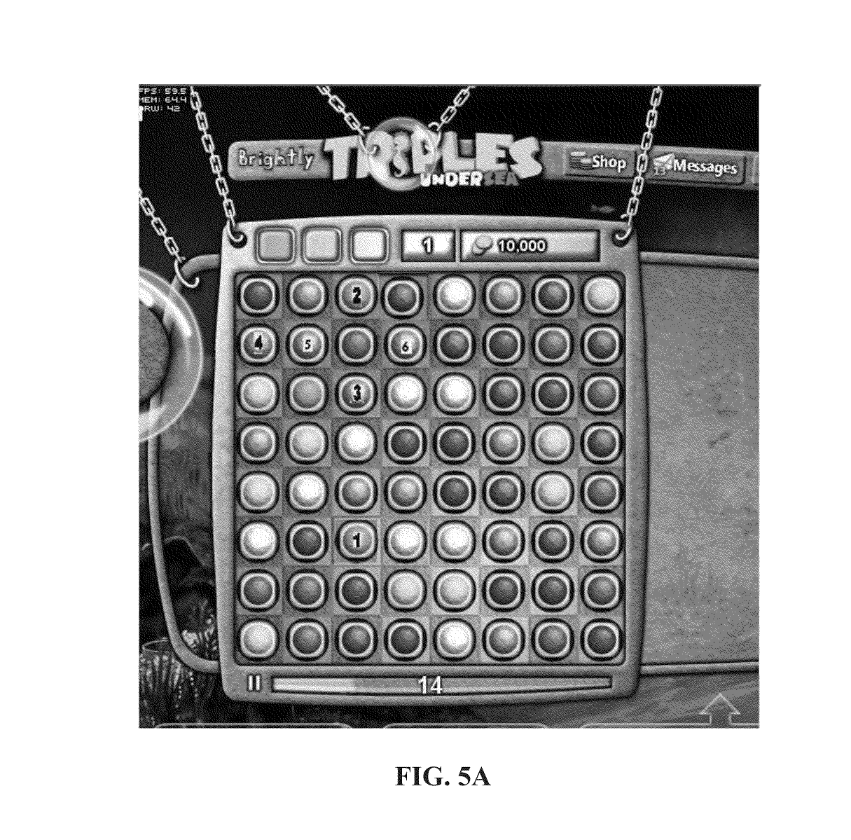

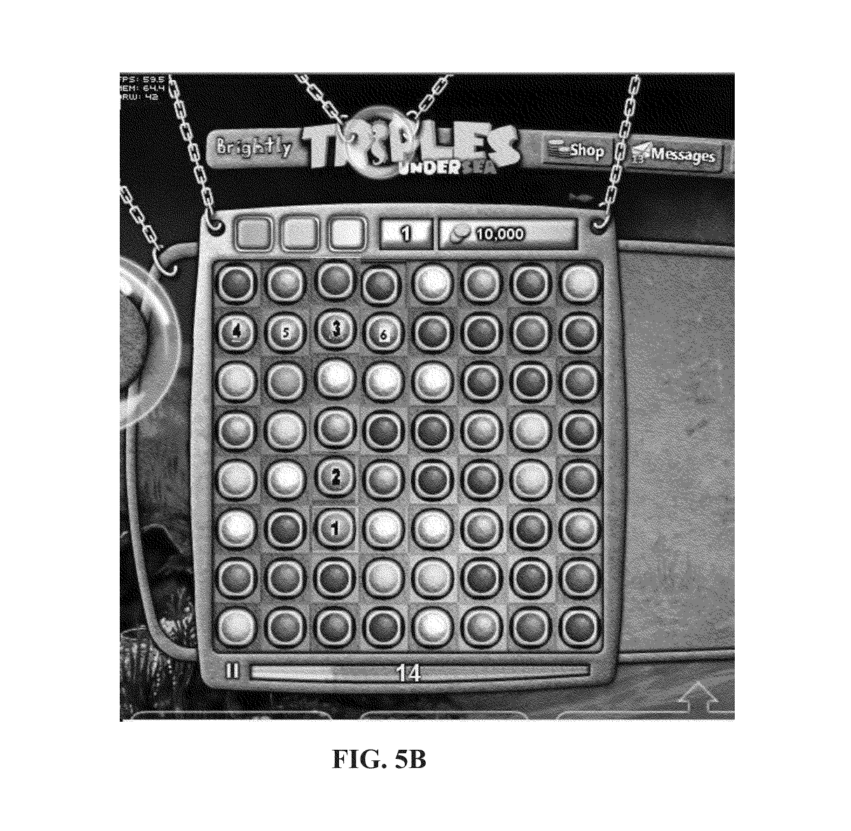

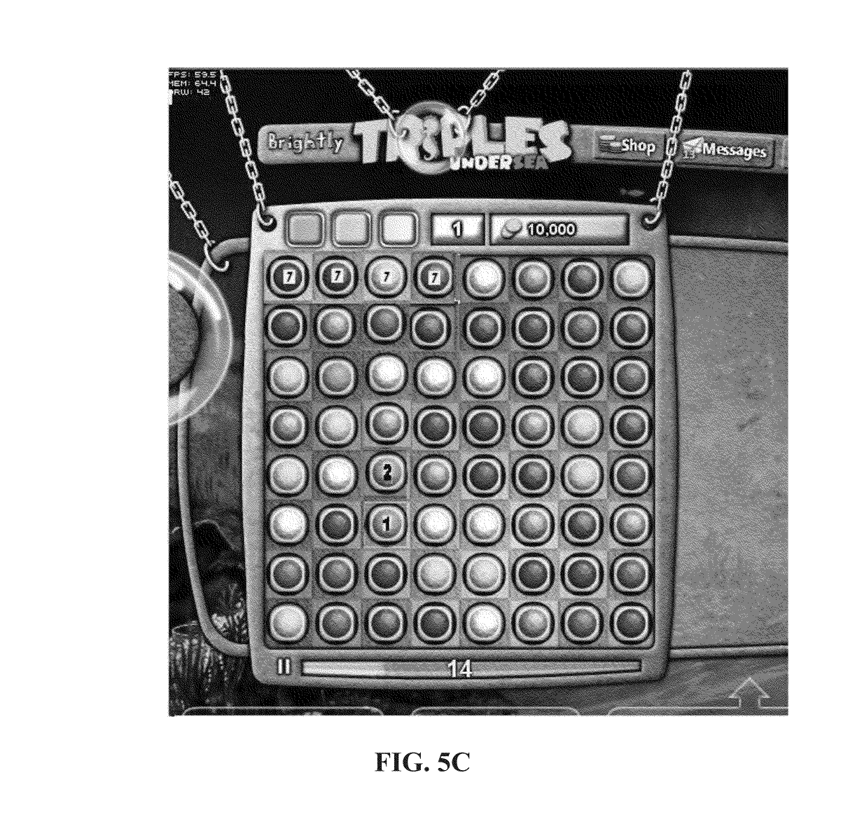

As shown at 105, identified uniform sequence(s) are removed from the mesh and optionally a set of replacement graphical objects are added to the mesh, for example randomly and/or according to a certain pattern, for example so as to maintain the number of graphical objects in the mesh. For example, FIG. 4 is a screenshot of the mesh depicted in FIG. 3, after the sequence of graphical objects “1”, “2”, and “3” has been formed after a selection of graphical object “1” and the relocating of the graphical objects “2”, and “3” in response to the selection. Another example is depicted in FIGS. 5A-5C which respectively depicts:

(1) an exemplary mesh before selecting an exemplary graphical object marked with “1”,

(2) the exemplary mesh after exemplary graphical object marked with “2” is relocated toward graphical object “1” in response to the selection of graphical object “1” and graphical object “3” is relocated to form a sequence with graphical objects “4”, “5”, and “6” which has the same color (orange), and

(3) the exemplary mesh after the formed sequence induces the relocation of the graphical objects thereabove and the addition of the graphical objects marked with “7”. As depicted in FIGS. 5A-5C, the formed sequence does not include the selected graphical object.

Another example is depicted in FIGS. 6A-6C wherein the time a user clicks (or taps) and/or taps on a selected graphical object determines the number of tiles each drawable graphical object moves towards the selected graphical object. In this example, FIGS. 6A-6C respectively depict:

(1) an exemplary mesh before selecting an exemplary graphical object marked with “1”,

(2) the exemplary mesh after exemplary graphical object marked with “2” is relocated toward graphical object “1” in response to a short click on the graphical object “1” and graphical objects “6” and “7” are relocated to evacuate the tile for the object marked with “2”, and

(3) the exemplary mesh after exemplary graphical object marked with “2” is relocated toward graphical object “3” in response to a short click on the graphical object “3” and graphical objects “5” is relocated to evacuate the tile for the object marked with “2”, forming a sequence with graphical objects “6” and “7”. As depicted in FIGS. 6A-6C, the user forms a sequence by a set of actions, moving graphical objects by timed clicks (and/or taps) on different selected graphical objects.

As shown at 106 and 107, as long as more sequences are available in the mesh that is generated with the added replacement graphical objects, the game session proceeds. In each game iteration, the user selects one graphical object and respective drawable graphical objects are relocated. Optionally, the user is scored according to the number and/or length of the sequences which are formed in each game iteration. For example, a sequence of 3 graphical objects provides 250 points, a sequence of 4 graphical objects provides 750 points, a sequence of 5 graphical objects provides 1000 points, and a sequence of 6 graphical objects provides 2000 points. Scores are accumulated to a sum that is defined as the score game session. As known in the art, the sum may be presented and compared to achievements of other users.

Optionally, drawable graphical objects are relocated even if no sequence is formed. Optionally, sequences formed without the selected graphical object are scored and treated as described with reference to 104-106. For example, such a sequence without the selected graphical object may provide higher points, for example 1000 points.

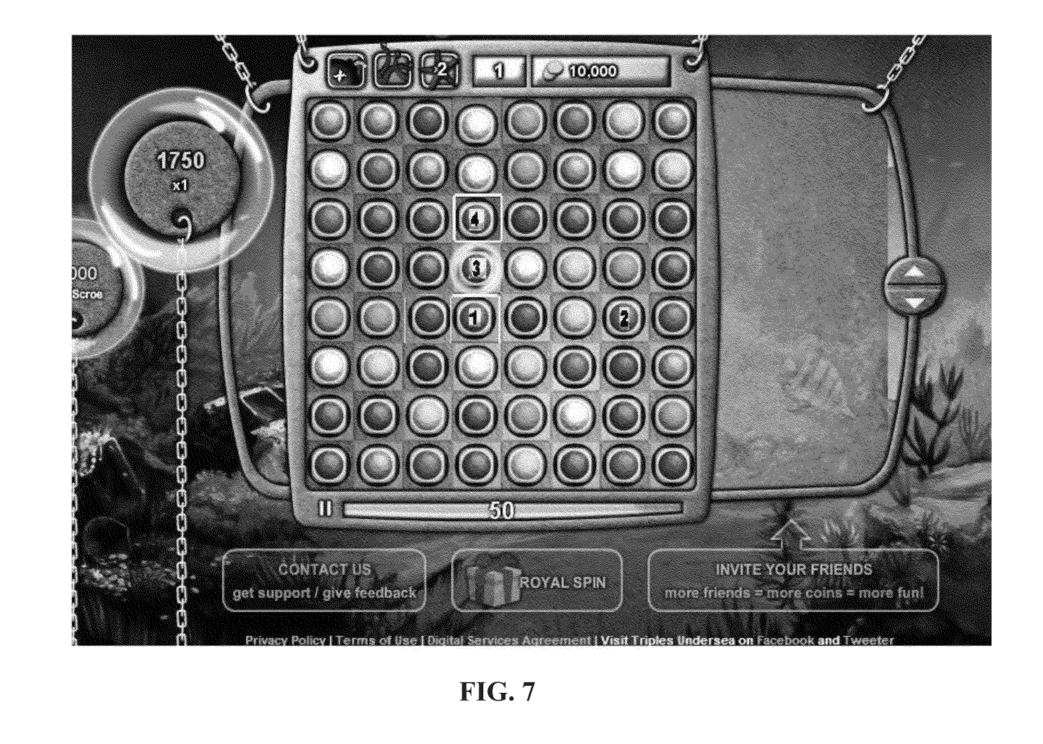

According to some embodiments of the present invention, forming a sequence with a graphical object that is visually tagged as providing a rule changing effect, for example an effect on the general rules of scoring and/or sequence generation. For example, when forming a sequence with a graphical object that is visually tagged with a time value, scores are doubled when granted, for example during a period that is displayed on a counter. The effect of forming a sequence with this graphical object lasts for a limited period. In another example, forming a sequence with a graphical object that is visually tagged with a bubble therearound, for example as shown at FIG. 7; all the graphical objects in the row and/or column of the graphical object with the bubble therearound are replaced with others and grant scores to the user. In another example, forming a sequence cannot be completed with a graphical object visually tagged with black color. Optionally, the above graphical objects are added during the game session in response to the creation of a certain sequence.

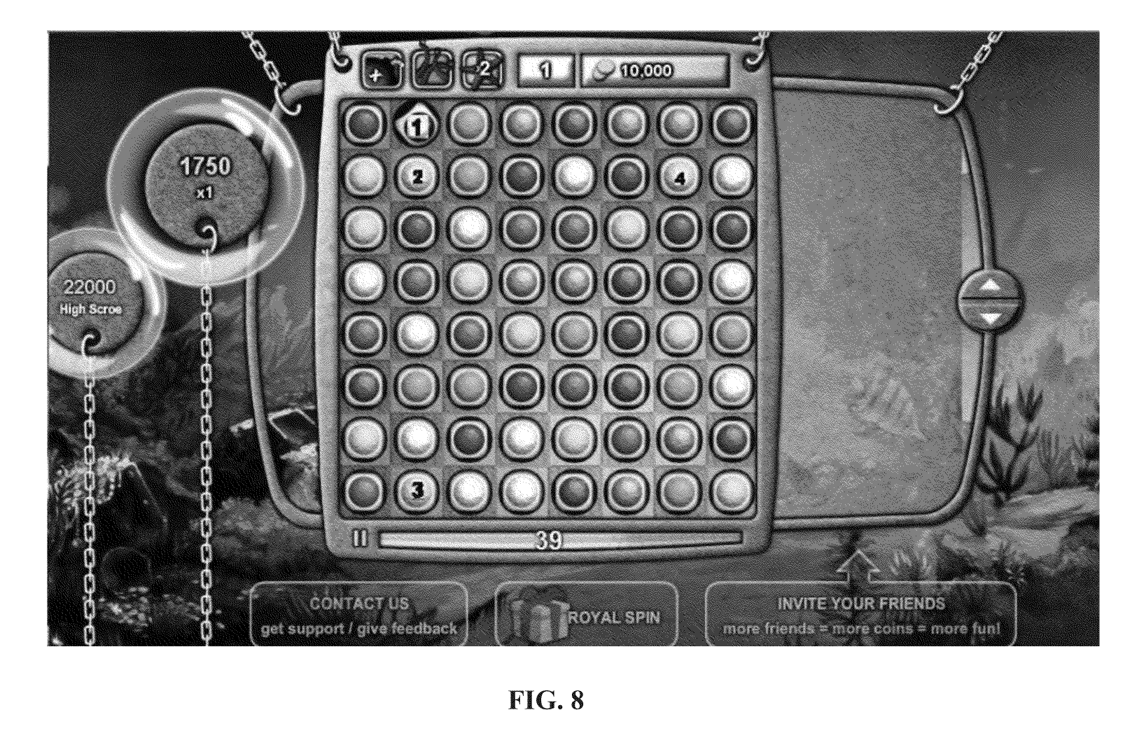

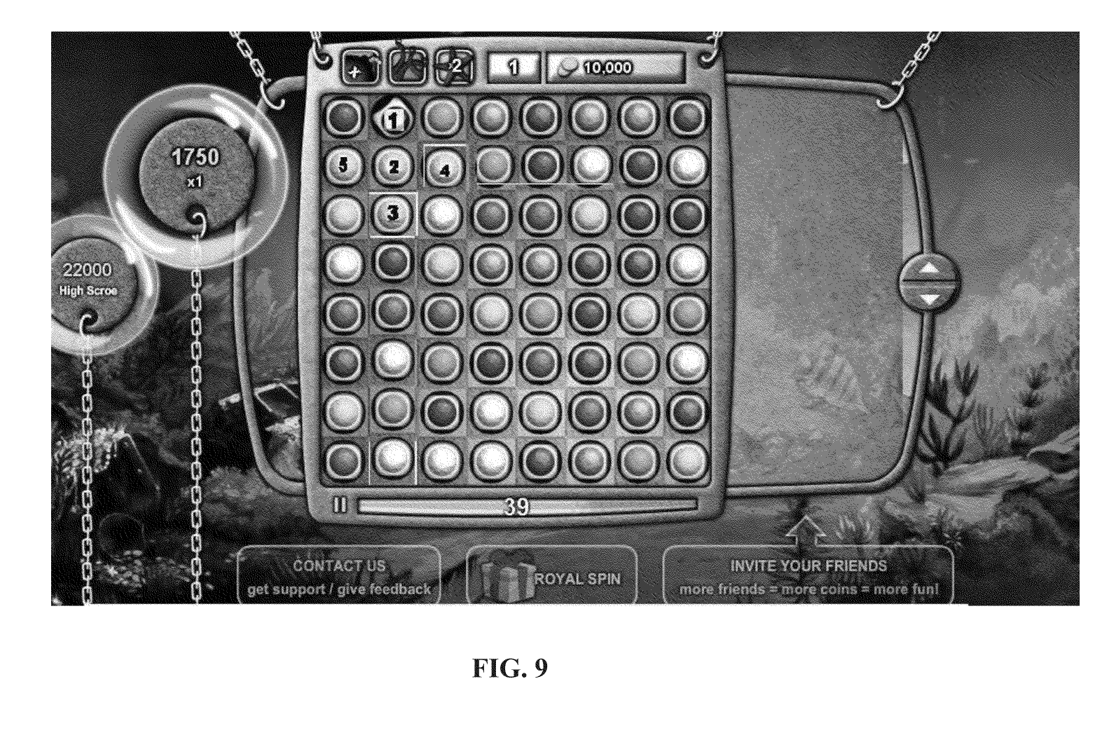

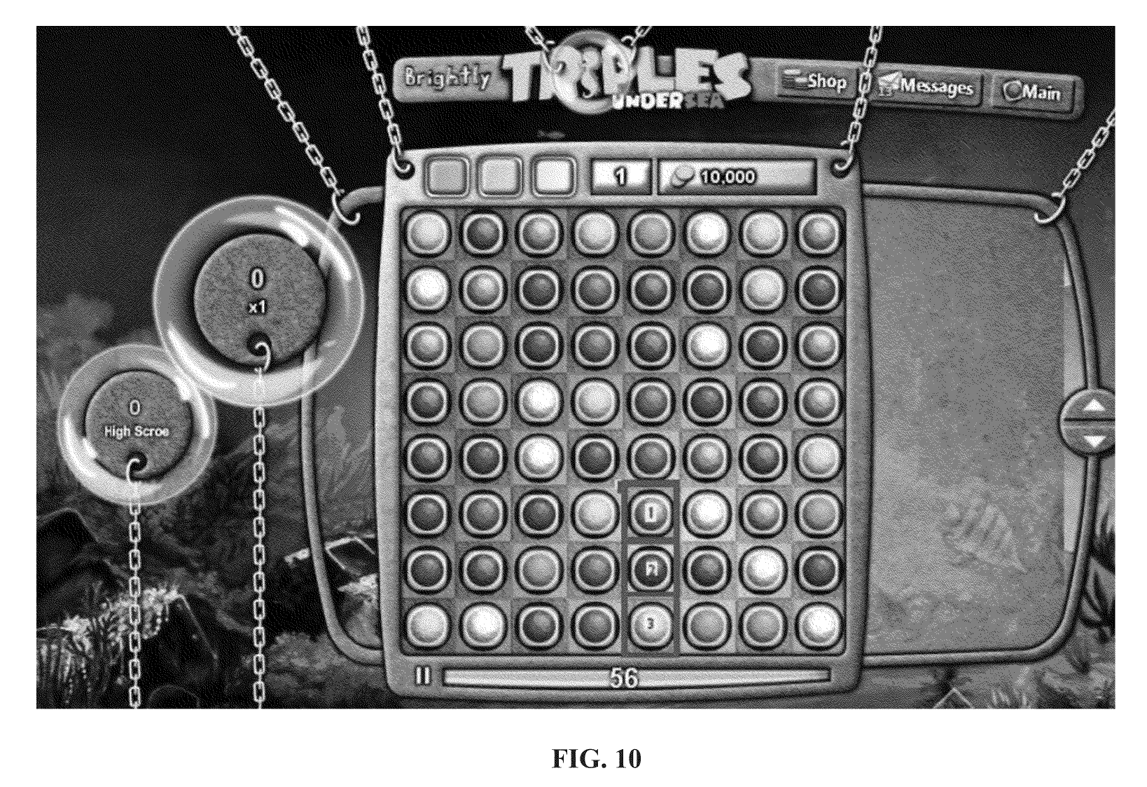

According to some embodiments of the present invention, a graphical object may complete a sequence with any two or more graphical objects having any common visual characteristic(s). These graphical objects may be referred to herein as dynamic graphical objects. For example, FIG. 8 is a screenshot of an exemplary mesh that includes a dynamic graphical object marked with numeral “1”. This dynamic graphical object completes a sequence with yellow labeled graphical objects which are formed when the graphical object marked with numeral “2” is selected. For example, FIG. 9 is a screenshot of the exemplary mesh after a user selected graphical object “2”. In this example, two sequences are formed, “5”, “2”, and “4” and “1”, “2”, and “3”.

According to some embodiments of the present invention, the game session is limited in time. For example, a user is granted with a certain amount of time for the game session. Optionally, each sequence adds more time to the total period left. When no time is left, the game session is over. In another example, a certain amount of time is granted per game iteration. Optionally, the time limit is user adjusted, for example selected according to a designated game level.

According to some embodiments of the present invention, a user may purchase and/or receive game tools. Optionally, the system 200 is integrated into a social media service, such as FacebookTM, a user may purchase game tools with Facebook moneyTM. Optionally, the game tools are refundable. Exemplary game tools includes: replacing graphical objects having one or more common visual characteristic(s) from the mesh with other graphical objects, rearranging all graphical objects in the mesh, rearranging graphical objects in selected columns and/or row of the mesh and/or the like, rearranging graphical objects having one or more common visual characteristic(s) to be adjacent to one another, forming a number of sequences, adjusting the tempo of rearranging graphical objects, replacing graphical objects in certain column(s) and/or row(s) and/or the like.

According to some embodiments of the present invention, a game session includes instructing a user to fill in a set of tiles with a sequence, optionally within a limited number of game rounds, for example 10 graphic object selections, and/or within a limited time frame.

According to some embodiments of the present invention, a game session is played by a number of players. For example each player selects a graphical object in one of a plurality of sequential game iterations and/or parallel game iterations. Optionally, if the selection induces a sequence of graphical objects, the score of the selecting player may be increased. Optionally, if the selection does not induce a sequence of graphical objects, the score of the selecting player may be decreased. The game maybe played for a limited number of rounds. Optionally, each player plays a number of rounds sequentially.

According to some embodiments of the present invention, the above methods and systems are implemented so that sequences are formed on diagonals of the mesh and not on rows and columns. In such embodiments, sequences are formed diagonally in response to graphical objects which are diagonally relocated.

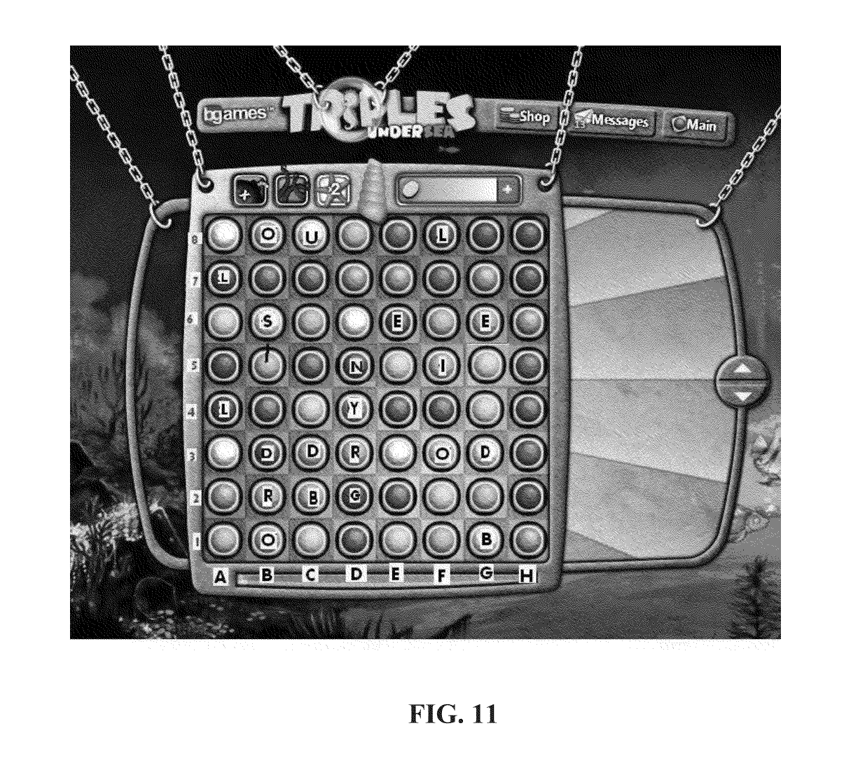

According to some embodiments of the preset invention there are provided methods and systems of controlling the location of graphical objects which are marked with letters in a mesh, such as the tile puzzle described above, during some or all of the iterations of a game session according to user selection(s). In each iteration, a user selects a graphical object marked with one or more letter(s) in a certain row and column of the mesh, for example a pearl with a certain letter. Optionally, the selection is made by a single click and/or finger tap on one of the graphical objects. In response to the selection, graphical objects in the certain row and column with the letters that can form a word with the letter in the selected graphical object, such as pearls with the different letters, are relocated, for instance moved toward and/or away from the selected graphical object. Sequence(s) of graphical objects with letter(s) which form a dictionary word as an outcome of the relocation are now identified and removed, for example of three or more letter words. In this case, the letters sequence has a meaning as letters in different sequences may or may not form words. These sequences optionally entitle the user with scores and replaced with new visual objects with new letters. These iterations are repeated during the game session, optionally under time constrain(s) and/or a limitation of rounds (i.e. number of game iterations). For example, FIG. 11 depicts graphical objects marked with letters which can be relocated by a number of selections, as described above, to form the words boy, girl, red, blue, and sun. In such embodiments, a dictionary of words may be used to match all possible combinations of letters (in graphical object) taken from row and/or column of a selected letter (graphical object).

It is expected that during the life of a patent maturing from this application many relevant systems and methods will be developed and the scope of the term a processor, a display, and a module is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of controlling a movement of a plurality of graphical objects in a mesh, comprising:
generating, using a processor, a display of a set of a plurality of graphical objects on a client terminal of a user, said plurality of graphical objects are arranged in a mesh having a plurality of columns and a plurality of rows, said plurality of graphical objects;
selecting by a user a graphical object having a differentiating visual characteristic from said plurality of graphical objects in a certain column from said plurality of columns and in a certain row from said plurality of rows;
in response to said selecting, automatically rearranging a group of graphical objects located in said certain row and said certain column in said mesh and having said differentiating visual characteristic;
identifying a presence or absence of at least one sequence of at least three neighboring graphical objects having a common differentiating visual characteristic in an outcome of said automatic rearranging; and
if said at least one sequence is identified, removing said at least one sequence from said mesh and adding a plurality of replacement graphical objects to said mesh.

2. The method of claim 1, wherein said automatically rearranging comprises relocating said group with neighboring graphical objects which are closer to said selected graphical object in said certain row and said certain column.

3. The method of claim 1, wherein said selecting is performed by one of a single selection action.

4. The method of claim 3, wherein said single selection action is a single finger tap on a touch screen displaying said mesh.

5. The method of claim 3, wherein said single selection action is a single click performed when a cursor is maneuvered to be correlated with a presentation of said selected graphical object.

6. The method of claim 1, further comprising sequentially and iteratively repeating said selecting, said automatically rearranging, said automatically checking, and said removing during a game session.

7. The method of claim 1, wherein said differentiating visual characteristic is selected from a group consisting of color, shape, and hue.

8. The method of claim 1, further comprising updating a score of said user according to said at least one sequence.

9. The method of claim 8, wherein said score is defined according to a length of said sequence.

10. The method of claim 1, wherein said selecting is performed by pressing or tapping on said selected graphical object for a period, wherein said rearranging is determined according to the length of said period.

11. The method of claim 10, wherein said period defines a number of tiles in said mesh each one of said graphical objects having said differentiating visual characteristic of said selected graphical object is relocated.

12. The method of claim 1, wherein said set comprises at least one bonus indicative graphical object; wherein said automatically checking comprises checking if said sequence includes said at least one bonus indicative graphical object.

13. The method of claim 12, wherein said at least one bonus indicative graphical object is reallocated during said rearrangement.

14. The method of claim 12, wherein said at least one bonus indicative graphical object remains in place during said rearrangement.

15. A computer readable medium comprising computer executable instructions adapted to perform the method of claim 1.

16. The method of claim 1, wherein further comprises display a set of target tiles in said mesh; wherein said at least one sequence is at least one sequence formed in said set of target tiles.

17. The method of claim 1, wherein said selecting, automatically rearranging, identifying, removing, and adding are performed per game iteration in a multiplayer game session; wherein in each said iteration said selecting is performed by another of a plurality of players.

18. A game system for allowing a user to control a movement of a plurality of graphical objects in a mesh, comprising:
a processor;
a mesh generation module which generates, using said processor, a display of a set of a plurality of graphical objects on a client terminal of a user, said plurality of graphical objects are arranged in a mesh having a plurality of columns and a plurality of rows, said plurality of graphical objects;
a user interface module which allows a user to select a graphical object having a differentiating visual characteristic from said plurality of graphical objects in a certain column from said plurality of columns and in a certain row from said plurality of rows;
wherein in response to said user selection, said mesh generation module automatically rearranges graphical objects having said differentiating visual characteristic of said selected graphical object in said certain row and said certain column; and
wherein said mesh generation module automatically identifies a presence or absence of at least one sequence of at least three neighboring graphical objects having a common differentiating visual characteristic in an outcome of said automatically rearranged mesh so that if said at least one sequence is formed, said at least one sequence is removed from said mesh.

19. The game system of claim 18, wherein said system is a mobile device that has a touch screen; wherein said user interface module which allows said user to select said graphical object by a single tap on said touch screen.

20. The game system of claim 18, wherein said system is a network node that forwards said display to be presented in a browser executed by a client terminal which is connected to said network node via a computer network.

21. The game system of claim 18, wherein said user interface allows said user to select said graphical object by tapping on a display or clicking when a cursor is on top of graphical object, said user interface detects a length of a period wherein said user performs said tapping or clicking and determines a relocation of said graphical objects having said differentiating visual characteristic of said selected graphical object accordingly.

22. A computerized method of controlling a movement of a plurality of graphical objects in a mesh, comprising:
generating, using a processor, a display of a set of a plurality of graphical objects on a client terminal of a user, said plurality of graphical objects are arranged in a mesh having a plurality of columns and a plurality of rows, said plurality of graphical objects;
iteratively performing the following in each of a plurality of game iterations:
selecting by a single tap of a user on a touch screen or a single click on a cursor control device a graphical object having a differentiating visual characteristic from said plurality of graphical objects in a certain column from said plurality of columns and in a certain row from said plurality of rows;
in response to said selecting, automatically rearranging graphical objects having said differentiating visual characteristic of said selected graphical object and located in said certain row and said certain column; and
scoring said user according to a presence or absence of at least one sequence having a common differentiating visual characteristic in an outcome of said automatic rearranging.

23. A computerized method of controlling a movement of a plurality of graphical objects in a mesh, comprising:
generating, using a processor, a display of a set of a plurality of graphical objects marked with a plurality of letters on a client terminal of a user, said plurality of graphical objects are arranged in a mesh having a plurality of columns and a plurality of rows, said plurality of graphical objects;
selecting by a user a graphical object having a letter from said plurality of graphical objects in a certain column from said plurality of columns and in a certain row from said plurality of rows;
in response to said selecting, automatically rearranging a group of graphical objects located in said certain row and said certain column in said mesh and having letters forming a word documented in a dictionary database;
identifying a presence or absence of at least one sequence of at least three neighboring graphical objects having letters forming a word documented in said dictionary database in an outcome of said automatic rearranging; and
if said at least one sequence is identified, removing said at least one sequence from said mesh and adding a plurality of replacement graphical objects to said mesh.
